(19) United States
(12) Patent Application Publication
(10) Pub. No.: US 2026/0140005 A1
(43) Pub. Date: May 21, 2026

(54) PROBABILISTIC REPRESENTATION METHOD FOR UNDERWATER EXPLOSION SHOCK WAVE LOAD BASED ON BAYESIAN REASONING

(71) Applicant: Jianghan University, Wuhan (CN)

(72) Inventors: Zhi LI, Wuhan (CN); Yongsheng JIA, Wuhan (CN); Xiaoguang ZHOU, Wuhan (CN); Chu GAO, Wuhan (CN); Yingkang YAO, Wuhan (CN); Jinshan SUN, Wuhan (CN); Quanmin XIE, Wuhan (CN); Nan JIANG, Wuhan (CN); Lisha XING, Wuhan (CN); Shuangji ZHANG, Wuhan (CN)

(73) Assignee: Jianghan University, Wuhan (CN)

(21) Appl. No.: 19/373,025

(22) Filed: Oct. 29, 2025

(30) Foreign Application Priority Data
Sep. 18, 2025 (CN) 202511332542.3

(51) Int. Cl. G01L 5/14; G06N 7/01

(52) U.S. Cl. CPC G01L 5/14; G06N 7/01

(57) ABSTRACT

A probabilistic representation method for underwater explosion shock wave load based on Bayesian reasoning is disclosed, relating to the field of underwater explosion load calculation. The method is based on Bayesian probability models of underwater shock wave loads, and performing probability representations of underwater explosion shock wave loads. The method is used to effectively represent uncertainty of underwater explosion shock wave loads, and to provide random inputs for modeling load variability for the design of explosion-proof underwater structures.

### TECHNICAL FIELD

The present disclosure relates to the field of underwater explosion load calculation, particularly a probabilistic representation method for underwater explosion shock wave load based on Bayesian reasoning.

### BACKGROUND

Underwater explosions have long posed a serious threat to critical infrastructure, including river-crossing and sea-crossing bridges, underwater tunnels and pipelines, reservoir dams, ports, and docks. Establishment of reasonable and accurate models of explosion loads is a prerequisite for analyzing and calculating the dynamic response and damage characteristics of underwater explosions.

The underwater explosion process is extremely complex, and the propagation law and characteristics of explosion load are affected by many factors, such as explosive type and composition, charge mode and size, explosion equivalent and position, properties of the medium itself, underwater environment characteristics and boundary conditions, sensor size and accuracy, etc. The inherent random characteristics of these factors lead to significant uncertainties in the strength and duration of underwater explosion load, which are typically the main causes for the significant deviation between actual load and the results calculated using empirical formulas.

The existing structural explosion-proof design code takes explosive loads as a given, employing conservative design and evaluation methods with the maximum explosive charge to ensure structural safety. However, it cannot quantify the assurance rate that the structure will meet its explosion-proof protection function under a certain explosion condition. Consequently, reliability-based explosion-proof protection design represents a crucial direction in structural engineering development. And it is essential to study the variability of structural explosion loads by considering uncertainties in explosion-proof structural design from a probabilistic perspective.

Therefore, a probabilistic representation method for underwater explosion shock wave load based on Bayesian reasoning is urgently needed.

### SUMMARY

In order to solve the above problems, the present disclosure provides a probabilistic representation method for underwater explosion shock wave load based on Bayesian reasoning, the method includes the following steps:
S1, acquiring past experimental data, obtaining sample data by analyzing and processing experimental data;
S2, taking a Cole empirical model as a prior model of Bayesian inference, obtaining a target probability distribution of load representation parameters and calculation errors by performing an uncertainty analysis on load representation parameters and calculation errors of the prior model in combination with the sample data;
S3, taking the target probability distribution as prior knowledge, updating and calculating the load representation parameters and calculation errors by using the Bayesian inference method, and obtaining a Bayesian probability model of underwater explosion shock wave load; and
S4, based on the Bayesian probability model of underwater explosion shock wave load, predicting and calculating the underwater explosion shock wave load.

Preferably, in S2, the specific content of taking the Cole empirical model as the prior model of Bayesian inference includes:
obtaining a pressure time history expression of underwater explosion shock wave based on a Cole's empirical formula, and then deriving the load representation parameters of underwater explosion shock wave;
the load representation parameters include a free field shock wave pressure peak pₘ, a time constant θ, an impulse I, and a shock wave specific energy density eₛ;
establishing a dimensionless empirical model for the load representation parameters.

Preferably, the pressure time history expression of underwater explosion shock is:

$$p ( t ) = {p}_{m} {e}^{- t / θ} ;$$

where p(t) is the pressure time history of underwater explosion shock wave; pₘ is the free field shock wave pressure peak; θ is the time constant, that is, the time that the peak value of the shock wave attenuates from pₘ to pₘ/e, t is a time, m is an explosive equivalent, and e is a natural constant;

based on the pressure time history expression of underwater explosion shock, a water density ρ_{w} and an underwater acoustic propagation velocity c_{w} are introduced, and the impulse I and the shock wave specific energy density eₛ are derived.

Preferably, the expression of the dimensionless empirical model is:

$$y = {{k}_{d} ( \frac{1}{Z} )}^{{a}_{d}} ;$$

in the formula, a response variable is y=(pₘ, θ/m^{1/3}, I/m^{1/3}, e₅/m^{1/3}), where m^{1/3} denotes a ⅓ power of the explosive equivalent;
the load representation parameters are k_{d}=(kₚ, k_{θ}, k_{I}, kₑ), α_{d}=(αₚ, α_{θ}, α_{I}, αₑ), where k_{d} and α_{d} denote a first calculation parameter and a second calculation parameter of the dimensionless empirical model expression, including calculation parameters kₚ and αₚ of a pressure peak prior model, calculation parameters k_{θ} and α_{θ} of a time constant prior model, calculation parameters k_{I} and α_{I} of an impulse prior model, and calculation parameters kₑ and αₑ of a shock wave specific energy density prior model;
where a scaled explosion distance Z can be expressed as:

$$Z = \frac{R}{{( m \cdot NEQ )}^{1 / 3}} ;$$

in the formula, R is an explosion distance; m is a mass of explosive; NEQ is Trinitrotoluene (TNT) equivalent.

Preferably, in S2, the specific content of obtaining the target probability distribution of load representation parameters and calculation errors by performing the uncertainty analysis on load representation parameters and calculation errors of the prior model in combination with the sample data includes:
presetting optional probability distribution types, and the optional probability distribution types include but are not limited to Normal distribution, Lognormal distribution, Weibull distribution and Gamma distribution;
fitting the load representation parameters by using the sample data, and obtaining power-law relationship characteristics between the load representation parameters and the scaled explosion distance Z;
obtaining goodness-of-fit test results by performing a goodness-of-fit test on the load representation parameters and optional probability distribution types using Anderson-Darling statistical values;
determining the target probability distribution of the load representation parameters according to the power-law relationship characteristics and the goodness-of-fit test results;
evaluating the Cole dimensionless empirical model by using a root mean square error RMSE, a coefficient of determination R² and a variation coefficient Cov, and then quantifying the deviation of the dimensionless empirical model to obtain a model error ME;
performing the Anderson-Darling goodness-of-fit test on interval characteristics of ME by dividing the scaled explosion distance Z into sections, and then determining the target probability distribution of the calculation error among the optional probability distribution types.

Preferably, the expression of the model error ME is:

$$ME = \frac{{y}_{test}}{{y}_{cal}} ;$$

in the formula, yₜₑₛₜ is a test value; y_{cal} is a calculated value of the model.

Preferably, the expression of the Bayesian probability model of underwater explosion shock wave load includes:
(1) a first Bayesian probability model with prior model load representation parameters k^{s}=(kₚ, k_{θ}, k_{I}, kₑ), α^{s}=(αₚ, α_{θ}, α_{I}, αₑ) and the model error σ as the parameters of the Bayesian probability model;

$${y}_{k} ( x , {Θ}_{k} ) = {y}_{k , d} ( x , {θ}_{k} ) + {σ}_{k} {ε}_{k} ;$$

(2) a second Bayesian probability model with a model correction term parameter βₖ and the model error σ as the parameters of the Bayesian probability model, and modifying a calculation result of the prior model by a model correction term ηₖ(x,βₖ);

$${y}_{k} ( x , {Θ}_{k} ) = {y}_{k , d} ( x , {θ}_{k} ) + {η}_{k} ( x , {β}_{k} ) + {σ}_{k} {ε}_{k} ;$$

In the formula, yₖ(x,Θₖ) is a probability model of the representation parameters of underwater explosion load, and the subscript k denotes different representation parameters, y_{k,d}(x,θₖ) and ηₖ(x,βₖ) are empirical models and their correction terms, respectively; x is an observable input random variable; Θₖ=(θₖ, βₖ, σₖ) is an unknown parameter of the probability model; σₖεₖ denotes a calculation error of the modified probability model; where σₖ is a standard deviation of the model, εₖ is a random variable that obeys the standard normal distribution, and θₖ denotes calculation parameters k_{d} and α_{d} of the empirical model y_{k,d′}, and βₖ is a calculation parameter of the second Bayesian probability model correction term ηₖ;
defining that the model variance σₖ² is mutually independent and linearly unrelated to the variable x, that is, for a given load representation parameter Θₖ, a variance of the probability model is Var[P(x,Θₖ)]=σₖ²;
the expression of the model correction term ηₖ(x,βₖ) is:

$${η}_{k} ( x , β ) = {β}_{k , 1} {h}_{k , 1} ( x ) + {β}_{k , 2} {h}_{k , 2} ( x ) + {β}_{k , 3} {h}_{k , 2}^{2} ( x ) ;$$

where β_{k,i} denotes an i^{th} calculation coefficient of the calculation parameters of the second Bayesian probability model correction term ηₖ, h_{k,i} is an ‘interpretation’ function of the shock wave load-related parameter correction term, and x is a variable of the ‘interpretation’ function.

Preferably, based on an observation data set yₖ, a posterior distribution of Bayesian probability model parameters is updated by the Bayesian theorem, the posterior distribution expression of Bayesian probability model parameters is as follows:

$$π ( {Θ}_{k} \vert {y}_{k} ) = \frac{L ( {y}_{k} \vert {Θ}_{k} ) π ( {Θ}_{k} )}{\int L ( {y}_{k} \vert {Θ}_{k} ) π ( {Θ}_{k} ) d {Θ}_{k}} = c \cdot L ( {y}_{k} \vert {Θ}_{k} ) π ( {Θ}_{k} ) ;$$

in the formula, π(Θₖ|yₖ) is a prior distribution of Bayesian probability model parameters; yₖ is an actual evidence sample vector, and yₖ=[y₁, y′₂, . . . , yₙ]; Θₖ is an unknown parameter of the probability model; π(Θₖ|yₖ) is a posterior distribution of Bayesian probability model parameters; L(yₖ|Θₖ) is a likelihood function, and the consistency between the model and the data is quantified, L(yₖ|Θₖ)=L(y₁, y₂, . . . , yₙ, Θₖ); c is a definite integral constant, and c denotes a regularization factor;

Preferably, when the evidence sample information comes from n independent experimental sets, the posterior distribution expression of Bayesian probability model parameters can be further expressed as:

$$π ( {Θ}_{k} \vert {y}_{k}^{1} , {y}_{k}^{2} , … , {y}_{k}^{n} ) = c \cdot {\prod }_{i = 1}^{n} L ( {y}_{k}^{i} \vert {Θ}_{k} ) π ( {Θ}_{k} ) ;$$

where i is an i^{th} data sample point of an n^{th} independent experimental data set, n is a number of independent experimental data sets, and π is a posterior distribution function.

According to the Bayesian probability model of underwater explosion shock wave load, the model calculation error is defined, and the expression of the model calculation error is as follows:

$${r}_{k} ( x , {Θ}_{k} ) = {y}_{k} ( x , {Θ}_{k} ) - {y}_{k , d} ( x , {θ}_{k} ) - {η}_{k} ( x , {β}_{k} ) ;$$

where rₖ is a model calculation error, y_{k,d} is an empirical model of underwater explosion shock wave load.

In view of the foregoing, the probabilistic representation method for underwater explosion shock wave load based on Bayesian reasoning of the present disclosure has the following advantages compared with the conventional technology:
1, in the present disclosure, the variation coefficient of load representation parameters is 0.03-0.48, and the variation coefficient of model error is 0.19-0.38, which reveals the significant uncertainty characteristics of underwater explosion shock wave load;
2, Bayesian inference method effectively improves the accuracy of parameter estimation, and RMSE is significantly reduced under limited sample conditions through parameter posterior sampling. Compared with conventional deterministic methods, Bayesian probability not only provides point estimation, but also quantifies the uncertainty of the model, which provides more comprehensive information for engineering risk assessment;
3, in the present disclosure, the established Bayesian probability model can effectively represent the uncertainty of underwater explosion shock wave load, and provide a random input field considering load variability for the explosion-proof reliability design of underwater structures. The model framework can be extended to the reliability analysis of other explosion load scenarios, providing a novel tool for risk assessment and uncertainty propagation research.

Further detailed descriptions of the technical scheme of the present disclosure can be found in the accompanying drawings and embodiments.

### BRIEF DESCRIPTION OF THE DRAWINGS

FIG. 1 is a histogram and a corresponding probability distribution diagram of each load representation parameter in an embodiment of the present disclosure, wherein (a) is a probability distribution diagram of a calculation parameter k_{θ}, (b) is a probability distribution diagram of a calculation parameter α_{θ}, (c) is a probability distribution diagram of a calculation parameter kₚ, (d) is a probability distribution diagram of a calculation parameter αₚ, (e) is a probability distribution diagram of a calculation parameter k_{I}, (g) is a probability distribution diagram of a calculation parameter kₑ, and (h) is a probability distribution diagram of a calculation parameter αₑ.

FIG. 2 is a comparison diagram between a test value and a predicted value of an underwater explosion load representation parameter in an embodiment of the present disclosure, wherein (a) is a comparison diagram between a test value and a predicted value of a time constant θ, (b) is a comparison diagram between a test value and a predicted value of a pressure peak value pₘ, (c) is a comparison diagram between a test value and a predicted value of an impulse I, and (d) is a comparison diagram between a test value and a predicted value of a shock wave specific energy density eₛ;

FIG. 3 is an error distribution of models with different scaled explosion distances in an embodiment of the present disclosure, wherein (a) is an error distribution of a time constant θ model, (b) is an error distribution of a pressure peak pₘ model, (c) is an error distribution of an impulse/model, and (d) is an error distribution of a shock wave specific energy density eₛ model;

FIG. 4 shows error mean values and variation coefficients of models with different scaled explosion distances in an embodiment of the present disclosure;

FIG. 5 is a hierarchical structure of a Bayesian probability model in an embodiment of the present disclosure.

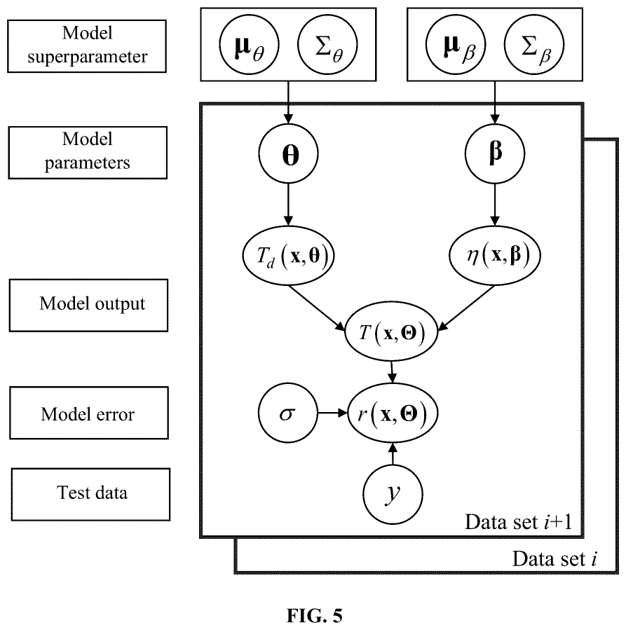

FIG. 6 is a posterior density distribution of time constants of each model of a Model I in an embodiment of the present disclosure, wherein (a) is a posterior distribution of a calculation parameter α_{θ}, (b) is a posterior distribution of a calculation parameter k_{θ}, (c) is a posterior distribution of a calculation parameter σ_{θ}, and (d) is a change of a standard deviation of a calculation parameter with a sample size;

FIG. 7 is a posterior density distribution of peak pressure of each model of a Model I in an embodiment of the present disclosure, wherein (a) is a posterior distribution of a calculation parameter αₚ, (b) is a posterior distribution of a calculation parameter kₚ, (c) is a posterior distribution of a calculation parameter σₚ, and (d) is a change of a standard deviation of a calculation parameter with a sample size;

FIG. 8 is a posterior density distribution of impulse of each model of a Model I in an embodiment of the present disclosure, wherein (a) is a posterior distribution of a calculation parameter α_{I}, (b) is a posterior distribution of a calculation parameter k_{I}, (c) is a posterior distribution of a calculation parameter σ_{I}, and (d) is a change of a standard deviation of a calculation parameter with a sample size;

FIG. 9 is a posterior density distribution of shock wave density of each model of a Model I in an embodiment of the present disclosure, wherein (a) is a posterior distribution of a calculation parameter αₑ, (b) is a posterior distribution of a calculation parameter kₑ, (c) is a posterior distribution of a calculation parameter σₑ, and (d) is a change of a standard deviation of a calculation parameter with a sample size;

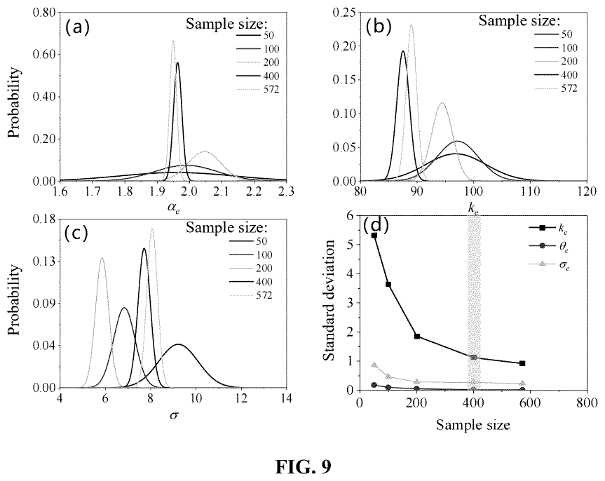

FIG. 10 is a posterior density distribution of time constants of each model of a Model II in an embodiment of the present disclosure, wherein (a) is a posterior distribution of a calculation parameter α_{θ}, (b) is a posterior distribution of a calculation parameter k_{θ}, (c) is a posterior distribution of a calculation parameter σ_{θ}, and (d) is a change of a standard deviation of a calculation parameter with a sample size;

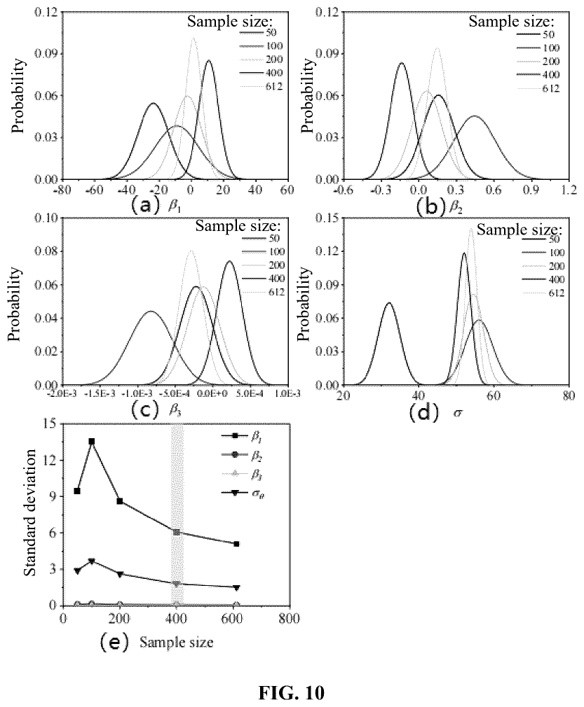

FIG. 11 is a posterior density distribution of peak pressure of each model of a Model II in an embodiment of the present disclosure, wherein (a) is a posterior distribution of a calculation parameter αₚ, (b) is a posterior distribution of a calculation parameter kₚ, (c) is a posterior distribution of a calculation parameter σₚ, and (d) is a change of a standard deviation of a calculation parameter with a sample size;

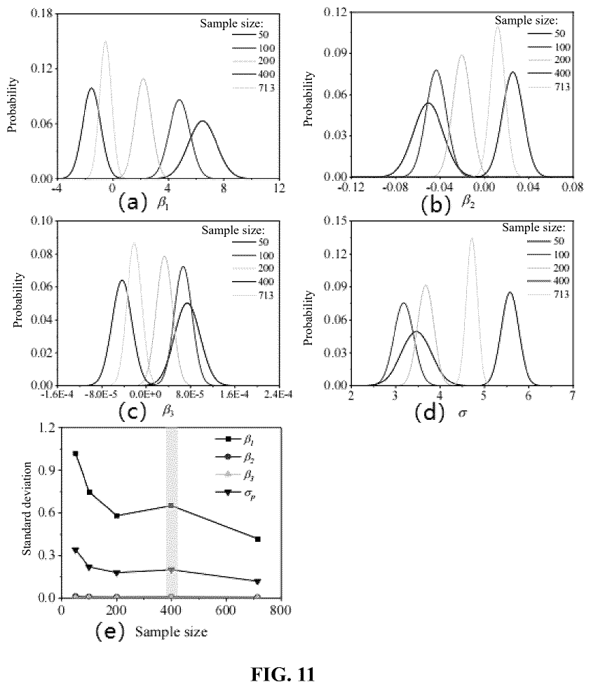

FIG. 12 is a posterior density distribution of impulse of each model of a Model II in an embodiment of the present disclosure, wherein (a) is a posterior distribution of a calculation parameter α_{I}, (b) is a posterior distribution of a calculation parameter k_{I}, (c) is a posterior distribution of a calculation parameter σ_{I}, and (d) is a change of a standard deviation of a calculation parameter with a sample size;

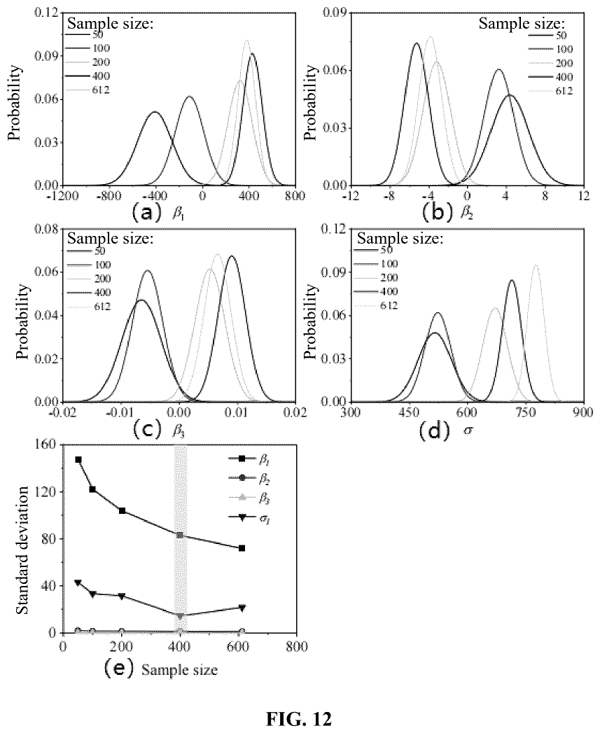

FIG. 13 is a posterior density distribution of shock wave density of each model of a Model II in an embodiment of the present disclosure, wherein (a) is a posterior distribution of a calculation parameter αₑ, (b) is a posterior distribution of a calculation parameter kₑ, (c) is a posterior distribution of a calculation parameter σₑ, and (d) is a change of a standard deviation of a calculation parameter with a sample size;

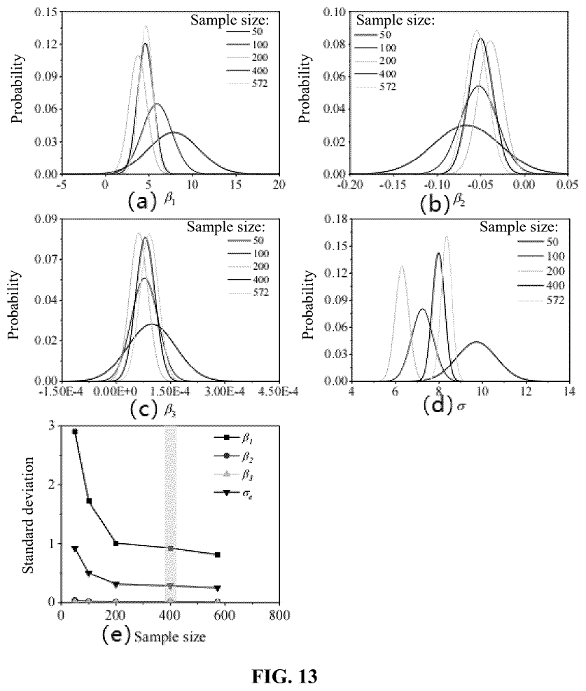

FIG. 14 is a comparison diagram between a measured value and a calculated value of each model in an embodiment of the present disclosure, wherein (a) is a comparison diagram between a test value and a predicted value of a time constant θ, (b) is a comparison diagram between a test value and a predicted value of a pressure peak value pₘ, (c) is a comparison diagram between a test value and a predicted value of an impulse I, and (d) is a comparison diagram between a test value and a predicted value of a shock wave specific energy density eₛ;

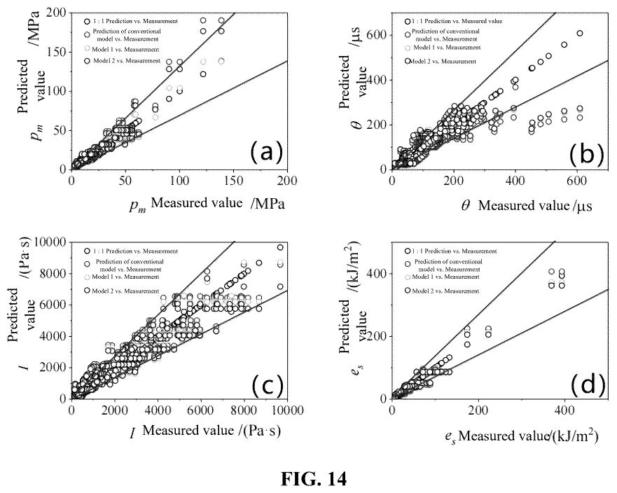

FIG. 15 is a flow diagram of a probabilistic representation method for underwater explosion shock wave load based on Bayesian reasoning according to the present disclosure.

### DETAILED DESCRIPTION OF THE EMBODIMENTS

The technical scheme of the present disclosure is further explained below by drawings and embodiments. It should be noted that unless otherwise specifically stated, the relative arrangement of components and steps, numerical expressions, and values described in these embodiments do not limit the scope of the present disclosure.

The following description of at least one exemplary embodiment is merely illustrative and is not intended to impose any limitation on the present disclosure or its application or use.

Techniques, systems, and equipment known to ordinary skilled in the relevant art may not be mentioned in detail, but techniques, systems, and equipment shall be considered part of the specification under appropriate circumstances.

In all embodiments illustrated and discussed herein, any specific values should be interpreted as merely exemplary and not as limitations. Therefore, other examples of exemplary embodiments may have different values.

Unless otherwise defined, the technical or scientific terms used in the present disclosure shall be those to which the present disclosure belongs.

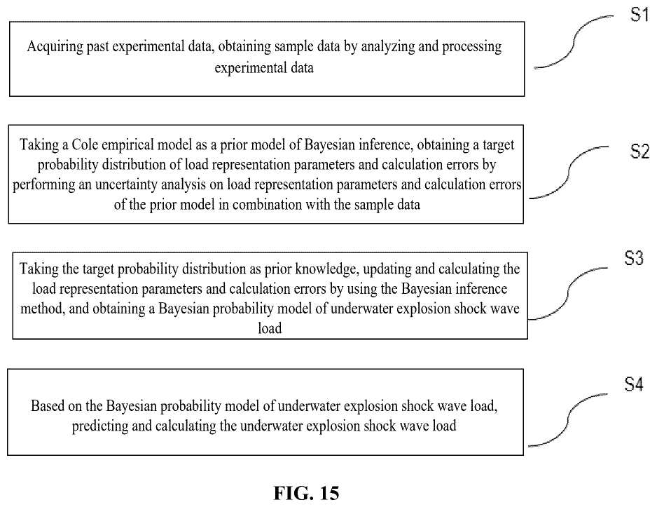

Underwater explosion shock wave loads exhibit significant variability and uncertainty. Classical deterministic empirical models have resulted in deviations between calculation results and measured data due to the omission of these characteristics. In the present disclosure, based on 682 sets of underwater explosion experimental data, an uncertainty analysis is performed on various explosion load parameters (the pressure peak pₘ, the time constant θ, the impulse I, and the shock wave energy density eₛ). A Bayesian probabilistic model integrating the Cole empirical model with physical correction terms is constructed. Parameters are calibrated using Bayesian inference to achieve a probabilistic representation of shock wave loads. The specific steps are shown in FIG. 15.

### EMBODIMENT

S1, the past experimental data is acquired, and the experimental data set of the sample data is obtained by analyzing and processing the experimental data.

The representation parameters of underwater explosion shock wave load mainly include pressure time history p(t), pressure peak value pₘ, time constant θ, impulse/and shock wave specific energy density eₛ. The present disclosure screens and collects a total of 682 sets of underwater explosion experimental data, including 677 sets of p data, 593 sets of θ data, 593 sets of I data and 553 sets of eₛ data. The collected data subjects represent small equivalent, shallow water conditions and mid-to-long-range underwater explosion scenarios. In view of the scarcity of underwater explosion experimental data, the statistics integrates field tests and indoor model box tests, covering TNT, cyclotrimethylenetrinitramine (RDX), cyclotetramethylenetetranitramine (HMX), hexanitrohexazaisowurtzitane (CL-20), emulsion explosives and other explosive types. The experimental design parameters include charge density, sensor sounding and ranging. Explosion load test parameters are mainly time constant, pressure peak, impulse, and specific energy density, etc. The statistical results are shown in Table 1.

TABLE 1
Design parameters and test data statistics of underwater explosion experiment

| | | | | Mean | Standard | Minimum | | Maximum | Variation |
|---|---|---|---|---|---|---|---|---|---|
| Variables | Symbol | Unit | Total | value | deviation | value | Median | value | coefficient |
| Charge | ρₑ | [g/cm³] | 639 | 1.62 | 0.26 | 0.60 | 1.65 | 2.10 | 0.16 |
| density | | | | | | | | | |
| Scaled | Z | [m/kg^{1/3}] | 682 | 4.26 | 3.75 | 0.32 | 3.25 | 29.55 | 0.88 |
| explosion | | | | | | | | | |
| distance | | | | | | | | | |
| Time | θ | [μs] | 593 | 95.13 | 83.54 | 5.50 | 71.64 | 608.70 | 0.88 |
| constant | | | | | | | | | |
| Peak | pₘ | [MPa] | 677 | 16.14 | 12.77 | 1.02 | 13 | 138.70 | 0.79 |
| pressure | | | | | | | | | |
| Impulse | I | [Pa · s] | 593 | 1652.72 | 1852.73 | 28.22 | 788.97 | 9665 | 1.12 |
| Specific | eₛ | [kJ/m²] | 553 | 14.07 | 32.54 | 0.03 | 3.59 | 392.88 | 2.31 |
| energy | | | | | | | | | |
| density | | | | | | | | | |

S2, the Cole empirical model of COLE R H, WELLER R. Underwater explosions [J]. Physics Today, 1948, 1 (6): 35′ is taken as the prior model of Bayesian inference, the target probability distribution of load representation parameters and calculation errors is obtained by performing the uncertainty analysis on the load representation parameters and calculation errors of the prior model in combination with the sample data.

Based on the Cole empirical formula, the pressure time history of underwater explosion shock can be expressed as:

$$p ( t ) = {p}_{m} {e}^{- t / θ} . \qquad ( 1 )$$

Where p(t) is the pressure time history of underwater explosion shock wave; pₘ is the free field shock wave pressure peak; θ is the time constant, that is, the time that the peak value of the shock wave attenuates from pₘ to pₘ/e, t is the time, m is the explosive equivalent, and e is the natural constant.

Based on the pressure time history curve, the impulse I and the shock wave specific energy density eₛ are derived under the conditions of known water density ρ_{w} and underwater acoustic propagation velocity c_{w}:

$$I = {\int }_{0}^{6.7 θ} p ( t ) dt ; \qquad ( 2 )$$

$${e}_{s} = \frac{1}{{ρ}_{w} {c}_{w}} {\int }_{0}^{6.7 θ} p ( t ) dt . \qquad ( 3 )$$

Where ρ_{w} is the density of the water medium, c_{w} is the sound velocity of the water medium, and p is the shock wave pressure. For the above representation parameters pₘ, θ, I and eₛ, the following dimensionless empirical models are established based on a large number of experimental data:

$$y = {{k}_{d} ( \frac{1}{Z} )}^{{α}_{d}} . \qquad ( 4 )$$

In the formula, the response variable is y=(pₘ, θ/m^{1/3}, I/m^{1/3}, eₛ/m^{1/3}), where m^{1/3} denotes the ⅓ power of the explosive equivalent; the load representation parameters are k_{d}=(kₚ, k_{θ}, k_{I}, kₑ), α_{d}=(αₚ, α_{θ}, α_{I}, αₑ), where k_{d} and α_{d} denote the first calculation parameter and the second calculation parameter of the dimensionless empirical model expression, including calculation parameters kₚ and αₚ of the pressure peak prior model, calculation parameters k_{θ} and α_{θ} of the time constant prior model, calculation parameters k_{I} and α_{I} of the impulse prior model, and calculation parameters kₑ and αₑ of the shock wave specific energy density prior model. The values depend on the properties of explosives and test scenarios, and the calibration of load representation parameters (k_{d},α_{d}) directly determines the accuracy of the model. In which, with consideration of different types of explosives, the scaled explosion distance Z can be expressed as:

$$Z = \frac{R}{{( m \cdot NEQ )}^{1 / 3}} ; \qquad ( 5 )$$

in the formula, R is the explosion distance; m is the mass of explosive; NEQ is the TNT equivalent.

A linear relationship can be obtained by taking the logarithm of Formula (4): In y=ln k_{d}−α_{d} ln Z (6), where y is the response variable of the dimensionless empirical model expression, k_{d} and α_{d} are the first calculation parameter and the second calculation parameter of the dimensionless empirical model expression.

The sample data are used to fit the load representation parameters, and the Anderson-Darling goodness-of-fit test is used to determine the probability distribution types of the load representation parameters.

The probability distribution types include but are not limited to Normal distribution, Lognormal distribution, Weibull distribution and Gamma distribution.

The fitting is performed on each representation parameter of the underwater explosion load based on experimental data, and the fitting results are shown in Table 2. It can be seen that all load representation parameters (θ, pₘ, I, eₛ) in the Cole empirical model exhibit significant power-law relationship characteristics with the scaled explosion distance Z, but with different degrees of dispersion. Among them, θ shows greater dispersion, indicating that this parameter is most sensitive to changes in environmental factors.

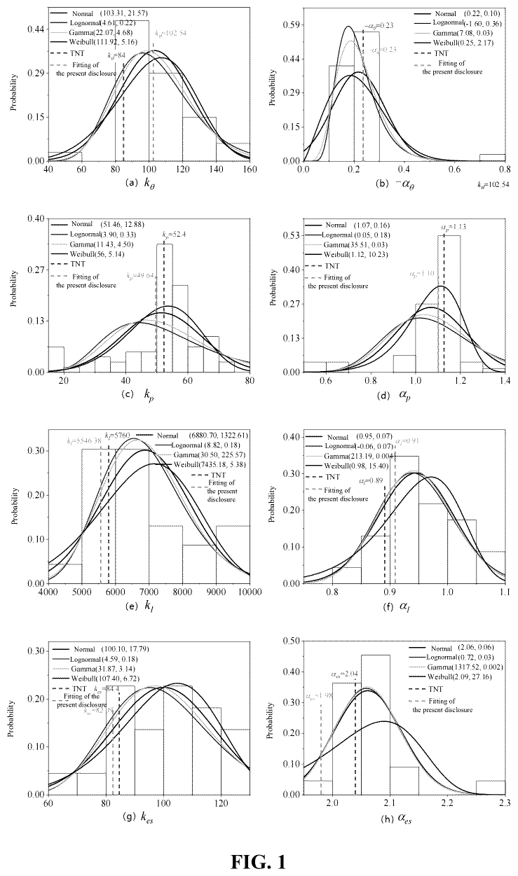

As shown in Table 3, the statistical characteristic description of the representation parameters of underwater explosion shock wave load is given in Table 3. The results show that the values of empirical load representation parameters have significant variability under different scenarios, and the range of the variation coefficient of each parameter is 0.03-0.48, among which the variation coefficient of load representation parameters of the time constant θ model is as high as 0.48. In order to determine the optimal probability distribution type of each load representation parameter, Normal distribution, Lognormal distribution, Weibull distribution and Gamma distribution are selected to perform the Anderson-Darling goodness-of-fit test to investigate the consistency between the sample data and the selected distribution model. The Anderson-Darling statistical value denotes the weighted square distance from the point in the probability graph to the fitting line, and the smaller the value, the better the distribution fitting. The goodness-of-fit test results of each load representation parameter are shown in Table 4, and the probability distribution comparison is shown in FIG. 1. The results show that the Anderson-Darling statistical values of each load representation parameter are generally small (as shown in Table 4), indicating that the selected probability distributions can better describe the parameter variability, but the significant difference of probability density curves at the tail of the distribution (as shown in FIG. 1) indicates that the model with better tail fitting performance should be selected. By comparing the analysis of Table 2, Table 4 and FIG. 1, it can be seen that the load representation parameters of TNT explosive and the fitting results of the present disclosure closely approach the statistical mean value of the parameters. Therefore, the probability calibration of load representation parameters can be achieved by evaluating the position characteristics of parameters in the probability distribution, such as the degree of deviation from the probability mean and median.

TABLE 2
Fitting results of representation parameters
of underwater explosion load

| | Load representation parameters | | | | | | | |
|---|---|---|---|---|---|---|---|---|
| | kₚ | αₚ | k_{θ} | α_{θ} | k_{I} | α_{I} | kₑ | αₑ |
| Fitting of | 49.64 | 1.10 | 102.54 | −0.23 | 5546.38 | 0.91 | 82.09 | 1.98 |
| the present | | | | | | | | |
| disclosure | | | | | | | | |
| TNT | 52.40 | 1.13 | 84 | −0.23 | 5760 | 0.89 | 84.40 | 2.04 |

TABLE 3
Statistics of parameter values of empirical formula for underwater explosion load

| Load | | | | | | | |
|---|---|---|---|---|---|---|---|
| representation | | Mean | Standard | Minimum | | Maximum | Variation |
| parameters | Total | value | deviation | value | Median | value | coefficient |
| kₚ | 75 | 51.46 | 12.88 | 17.36 | 53.30 | 74.40 | 0.25 |
| αₚ | 75 | 1.07 | 0.16 | 0.55 | 1.11 | 1.37 | 0.15 |
| k_{θ} | 34 | 103.31 | 21.57 | 44.11 | 99.96 | 154.00 | 0.21 |
| α_{θ} | 34 | −0.22 | 0.10 | −0.72 | −0.22 | −0.10 | 0.48 |
| k_{I} | 23 | 6880.70 | 1322.61 | 4910 | 6455 | 9575 | 0.19 |
| α_{I} | 23 | 0.95 | 0.07 | 0.80 | 0.93 | 1.09 | 0.07 |
| kₑ | 22 | 100.10 | 17.79 | 69.57 | 105.51 | 128.25 | 0.18 |
| αₑ | 22 | 2.06 | 0.06 | 1.97 | 2.06 | 2.26 | 0.03 |

TABLE 4
Anderson-Darling goodness-of-fit test results
for each load representation parameter

| Distribution | Load representation parameters | | | | | | | |
|---|---|---|---|---|---|---|---|---|
| function | kₚ | αₚ | k_{θ} | α_{θ} | k_{I} | α_{I} | kₑ | αₑ |
| Normal | 3.37 | 6.56 | 0.98 | 2.58 | 1.15 | 0.37 | 0.43 | 0.76 |
| Lognormal | 6.91 | 9.40 | 0.93 | 0.81 | 0.83 | 0.36 | 0.49 | 0.68 |
| Weibull | 2.66 | 3.56 | 1.22 | 2.44 | 1.32 | 0.54 | 0.42 | 2.02 |
| Gamma | 5.65 | 8.43 | 0.85 | 1.07 | 0.96 | 0.36 | 0.50 | 0.67 |

The Cole dimensionless empirical model is evaluated by using the root mean square error RMSE, the coefficient of determination R² and the variation coefficient Cov, and then the deviation of the dimensionless empirical model is quantified to obtain the model error ME;

$$RMSE = \sqrt{\frac{{\sum }_{i = 1}^{N} {( {y}_{e} - {y}_{pre} )}^{2}}{N}} , \qquad ( 7 )$$

$${R}^{2} = 1 - \frac{{\sum }_{i = 1}^{N} {( {y}_{e} - {y}_{pre , i} )}^{2}}{{\sum }_{i = 1}^{N} {( {y}_{e , i} - {\overline{y}}_{e} )}^{2}} , \qquad ( 8 )$$

$$Cov = \sqrt{\frac{1}{N} {\sum }_{i = 1}^{N} {( \frac{{y}_{pre , i}}{{y}_{e , i}} - \frac{1}{N} {\sum }_{i = 1}^{N} \frac{{y}_{pre , i}}{{y}_{e , i}} )}^{2}} . \qquad ( 9 )$$

In the formula, yₑ is the experimental test result; yₚᵣₑ is the calculation result of the prior model; and N is the number of samples.

The smaller the RMSE and Cov values, and the closer the R² value to 1, indicating higher the model prediction accuracy. The evaluation results of each empirical model are shown in Table 5. The results show that except for the R²<0.8 of the θ model, and the R²>0.9 of the pₘ, I, and eₛ models, a better deterministic accuracy is shown, but the variation coefficient ranges from 0.297 to 0.580, which indicates the significant random uncertainty.

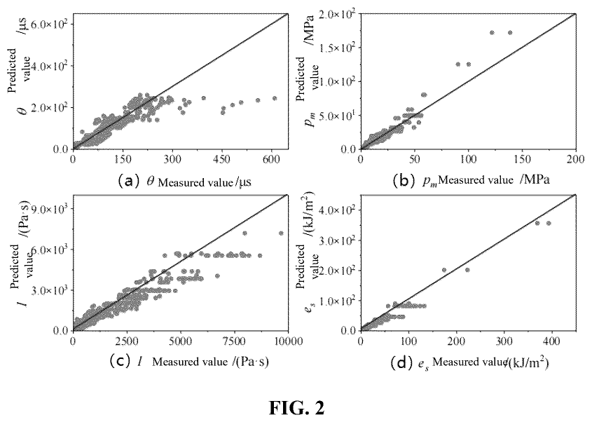

FIG. 2 shows the prediction performance of the empirical model for each representation parameter of underwater explosion load. In general, when the load representation parameters θ, pₘ, I and eₛ are small, they are primarily distributed near the contour lines of measured values and calculated values (red diagonal lines). For the working condition with large θ (θ>200 μs), the calculation results of the model are generally low. For the working condition with large pₘ (pₘ>60 MPa), the calculation results of the model are higher on average. The calculation results of the I and eₛ models are systematically underestimated, and with the increase of impulse I, the dispersion degree of the calculation results of the model gradually increases. It is due to the fact that under the working condition of a relatively small scaled distance, on the one hand, the ionization effect caused by high temperature and pressure makes the uncertainty of the parameters of the explosion load greater; on the other hand, for smaller explosive masses, although the energy contained in the detonator is minimal, it significantly impacts the experimental results.

TABLE 5
Evaluation results of empirical model of underwater explosion load

| Calculation model | θ | pₘ | I | eₛ |
|---|---|---|---|---|
| RMSE | 41.13 | 5.37 | 504.92 | 6.86 |
| R² | 0.75 | 0.84 | 0.92 | 0.95 |
| Cov | 0.42 | 0.22 | 0.57 | 1.03 |

In the consideration of the influence of random noise signals, the model error between the test value and the calculated value should present an optimal normal distribution with a non-zero mean value. To quantify the model systematic bias, the Model Error (ME) is defined as:

$$ME = \frac{{y}_{test}}{{y}_{cal}} . \qquad ( 10 )$$

In the formula, yₜₑₛₜ is the test value; and y_{cal} is the calculated value of the model. The statistical results of ME are shown in Table 6. The results show that the mean value and median of the ME of each model range from 0.93 to 1.13 and 0.91 to 1.07, respectively, while the variation coefficients range from 0.19 to 0.38, with significant variability. The goodness-of-fit of the probability distribution evaluated for ME by the Anderson-Darling test is shown in Table 7. The results show that the ME optimal distributions of load representation parameters θ, pₘ, I and eₛ are Lognormal distribution, Normal distribution, Weibull distribution and Gamma distribution in order, among which only the pₘ exhibits optimal fitting for the normal distribution of model errors, reflecting that the prediction accuracy of the pₘ model is more accurate. The ME distribution of I and eₛ models shows mild right-skewed characteristics, and the ME distribution of the θ model shows obvious right-skewed characteristics, that is, the proportion of samples with ME(θ)<1 is higher, indicating that the calculated value of the θ model generally gives a higher predicted value.

TABLE 6
Statistical description of model errors

| | | | | | Mini- | | Maxi- |
|---|---|---|---|---|---|---|---|
| Model | | Mean | Standard | Variation | mum | | mum |
| errors | Total | value | deviation | coefficient | value | Median | value |
| ME(θ) | 593 | 1.08 | 0.40 | 0.38 | 0.29 | 0.99 | 2.71 |
| ME(pₘ) | 677 | 1.02 | 0.19 | 0.19 | 0.46 | 1.02 | 1.55 |
| ME(I) | 593 | 1.06 | 0.33 | 0.31 | 0.20 | 1.06 | 2.12 |
| ME(eₛ) | 553 | 1.07 | 0.36 | 0.34 | 0.11 | 1.02 | 2.49 |

TABLE 7
Anderson-Darling goodness-of-fit test results for model error

| | |
|---|---|
| Distribution | Model errors |

| function | ME(θ) | ME(pₘ) | ME(I) | ME(eₛ) |
|---|---|---|---|---|
| Normal | 10.42 | 1.59 | 2.39 | 3.20 |
| Lognormal | 1.63 | 3.55 | 8.32 | 5.63 |
| Weibull | 9.09 | 5.54 | 2.01 | 4.37 |
| Gamma | 2.76 | 2.24 | 4.84 | 2.39 |

The Anderson-Darling goodness-of-fit test is performed on the interval characteristics of ME by dividing the scaled explosion distance Z into sections to determine the random frame among the optional probability distribution types.

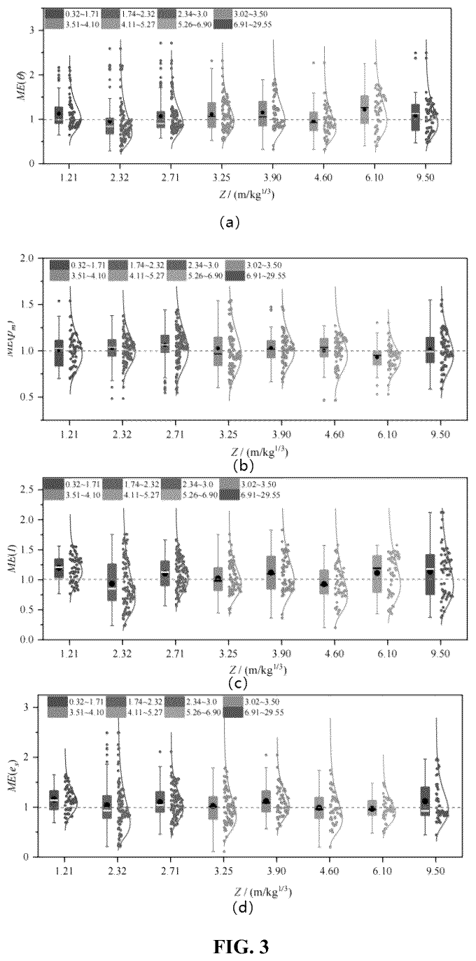

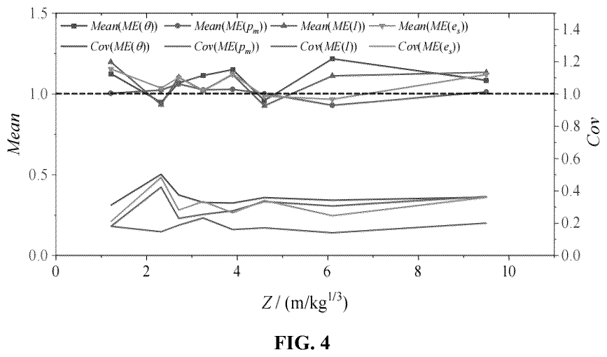

In view of the sample size differences for different scaled explosion distances, the interval characteristics of ME will be analyzed by dividing the Z into sections. Based on the theory of sample mean estimation, the minimum effective sample size is determined using the following formula:

$$n = {( \frac{{z}_{α / 2} σ}{E} )}^{2} . \qquad ( 11 )$$

Where n is the sample size; z_{α/2} is the standard differentiation number when the confidence level is 1-α, if the confidence level is 95%, the value of z_{α/2} is 1.96; σ is the standard deviation of the sample. Since the value of σ is unknown, the standard value of the population sample is used instead; E is the allowable mean value estimation error at a given confidence level, and the allowable mean value estimation error in this explosion load analysis is 10%. It is inferred that the minimum sample sizes of θ, pₘ, I and eₛ in each scaled explosion distance interval are 56, 14, 37 and 45 respectively. The ME distribution of each load representation parameter under different scaled explosion distances is shown in FIG. 3 and FIG. 4. It can be seen from the figures that the mean value error of pₘ model is closer to 1 than other models, and the variation coefficient is relatively low, indicating that the accuracy of the peak pressure model is relatively high. For other representation parameter calculation models, the mean value error of each explosion parameter model under different scaled explosion distances is mostly greater than 1, which indicates that the calculation results of θ, I and eₛ models are relatively high, and all three models show large variability, but with the increase of scaled explosion distance, the mean values and variability of the three models converge to stability.

Table 8 shows the Anderson-Darling goodness-of-fit test results of each load model error under different scaled explosion distances. The results show that the Anderson-Darling statistics of each load model error under Normal distribution, Lognormal distribution, Weibull distribution and Gamma distribution are all small, that is, each probability density function can well describe the probability distribution of each model error, among which Normal distribution and Gamma distribution are more obvious. Through the fitting results of the optimal probability distribution, the model error can be evaluated by judging the position of the model error in the probability distribution and its proximity to the mean value and median of the probability model.

TABLE 8
Anderson-Darling goodness-of-fit test results of each load
model error under different scaled explosion distances

| | | | Statistical result | | | | | |
|---|---|---|---|---|---|---|---|---|
| Model | Z | | Mean | variation | Distribution function | | | |
| error | Interval | Median | value | coefficient | Normal | Lognormal | Weibull | Gamma |
| ME(θ) | 0.32~1.71 | 1.21 | 1.13 | 0.31 | 3.31 | 1.67 | 3.36 | 2.17 |
| | 1.74~2.32 | 2.32 | 0.95 | 0.50 | 5.37 | 1.14 | 3.68 | 2.00 |
| | 2.34~3.00 | 2.71 | 1.07 | 0.37 | 7.23 | 3.61 | 6.72 | 4.71 |
| | 3.02~3.50 | 3.25 | 1.11 | 0.33 | 1.19 | 0.54 | 1.12 | 0.62 |
| | 3.51~4.10 | 3.90 | 1.15 | 0.32 | 2.01 | 1.27 | 1.90 | 1.38 |
| | 4.11~5.27 | 4.60 | 0.96 | 0.36 | 0.46 | 0.67 | 0.60 | 0.38 |
| | 5.27~6.90 | 6.10 | 1.22 | 0.34 | 0.64 | 1.85 | 0.68 | 1.36 |
| | 6.91~29.55 | 9.50 | 1.08 | 0.36 | 0.98 | 0.99 | 1.14 | 0.81 |
| ME(pₘ) | 0.32~1.71 | 1.21 | 1.00 | 0.18 | 0.46 | 0.68 | 0.64 | 0.58 |
| | 1.74~2.32 | 2.32 | 1.02 | 0.15 | 0.60 | 1.53 | 0.77 | 1.10 |
| | 2.34~3.00 | 2.71 | 1.06 | 0.19 | 1.09 | 2.94 | 0.69 | 2.17 |
| | 3.02~3.50 | 3.25 | 1.03 | 0.23 | 1.96 | 0.73 | 2.53 | 1.05 |
| | 3.51~4.10 | 3.90 | 1.03 | 0.16 | 0.70 | 0.62 | 1.70 | 0.58 |
| | 4.11~5.27 | 4.60 | 1.00 | 0.17 | 1.65 | 2.81 | 0.98 | 2.36 |
| | 5.27~6.90 | 6.10 | 0.93 | 0.14 | 0.70 | 0.98 | 1.19 | 0.82 |
| | 6.91~29.55 | 9.50 | 1.01 | 0.20 | 0.35 | 0.48 | 0.72 | 0.36 |
| ME(I) | 0.32~1.71 | 1.21 | 1.20 | 0.18 | 0.68 | 1.00 | 0.55 | 0.90 |
| | 1.74~2.32 | 2.32 | 0.93 | 0.42 | 1.13 | 0.80 | 0.67 | 0.52 |
| | 2.34~3.00 | 2.71 | 1.10 | 0.23 | 0.50 | 0.74 | 0.51 | 0.58 |
| | 3.02~3.50 | 3.25 | 1.02 | 0.25 | 1.13 | 0.75 | 1.37 | 0.75 |
| | 3.51~4.10 | 3.90 | 1.12 | 0.28 | 1.49 | 1.48 | 1.47 | 1.41 |
| | 4.11~5.27 | 4.60 | 0.93 | 0.33 | 0.35 | 1.60 | 0.40 | 0.89 |
| | 5.27~6.90 | 6.10 | 1.11 | 0.31 | 2.32 | 3.25 | 2.52 | 2.93 |
| | 6.91~29.55 | 9.50 | 1.13 | 0.36 | 0.64 | 1.19 | 0.60 | 0.88 |
| ME(eₛ) | 0.32~1.71 | 1.21 | 1.15 | 0.21 | 0.31 | 0.41 | 0.42 | 0.33 |
| | 1.74~2.32 | 2.32 | 1.04 | 0.48 | 2.19 | 1.78 | 1.45 | 1.09 |
| | 2.34~3.00 | 2.71 | 1.10 | 0.28 | 0.62 | 0.46 | 0.73 | 0.33 |
| | 3.02~3.50 | 3.25 | 1.02 | 0.33 | 0.32 | 1.34 | 0.34 | 0.52 |
| | 3.51~4.10 | 3.90 | 1.12 | 0.26 | 0.28 | 0.18 | 0.46 | 0.13 |
| | 4.11~5.27 | 4.60 | 0.99 | 0.34 | 0.18 | 1.36 | 0.22 | 0.67 |
| | 5.27~6.90 | 6.10 | 0.97 | 0.25 | 0.31 | 0.75 | 0.35 | 0.53 |
| | 6.91~29.55 | 9.50 | 1.12 | 0.36 | 2.72 | 1.45 | 2.39 | 1.85 |

S3, the target probability distribution is taken as prior knowledge, the load representation parameters and calculation errors are updated and calculated by using the Bayesian inference method, and the Bayesian probability model of underwater explosion shock wave load is obtained. The expression of the Bayesian probability model of underwater explosion shock wave load includes:
(1) the first Bayesian probability model with prior model load representation parameters k^{s}=(kₚ, k_{θ}, k_{I}, kₑ), α³=(αₚ, α_{θ}, α_{I}, αₑ) and the model error σ as the parameters of the Bayesian probability model;

$${y}_{k} ( x , {Θ}_{k} ) = {y}_{k , d} ( x , {Θ}_{k} ) + {σ}_{k} {ε}_{k} .$$

(2) The second Bayesian probability model with the model correction term parameter βₖ and the model error σ as the parameters of the Bayesian probability model, and the calculation result of the prior model is modified by the model correction term ηₖ(x,βₖ);

$${y}_{k} ( x , {Θ}_{k} ) = {y}_{k , d} ( x , {Θ}_{k} ) + {η}_{k} ( x , {β}_{k} ) + {σ}_{k} {ε}_{k} . \qquad ( 12 )$$

In the formula, yₖ(x,Θₖ) is the probability model of the representation parameters of underwater explosion load, and the subscript k denotes different representation parameters; y_{k,d}(x,θₖ) and ηₖ(x,βₖ) are empirical models and their correction terms, respectively, which reflect model uncertainty. The empirical model can be further expanded and combined with the various factors affecting underwater explosion load variations through the correction term to enhance model accuracy. x is the observable input random variable, such as explosive mass, explosion location information, explosive properties, and measurement errors, which reflect the uncertainty in the input parameters of the model; Θₖ=(Θₖ, βₖ, σₖ) is the unknown parameter of the probability model; σₖεₖ denotes the calculation error of the modified probability model, which comprehensively reflects the model uncertainty from the computational model, input parameters, and experimental testing aspects; where σₖ is the standard deviation of the model, εₖ is the random variable that obeys the standard normal distribution, and θₖ denotes calculation parameters k_{d} and α_{d} of the empirical model y_{k,d}; and βₖ is the calculation parameter of the second Bayesian probability model correction term ηₖ.

To appropriately simplify subsequent analysis, it is assumed here that the model variance σₖ² is mutually independent and linearly unrelated to the variable x, that is, for the given load representation parameter Θₖ, the variance of the probability model is Var[P(x,Θₖ)]=σₖ².

For the determination of the model correction term ηₖ(x,βₖ), it can be expressed by a linear combination of a series of basic elementary functions hᵢ(x) based on engineering experience and mechanism analysis:

$${η}_{k} ( x , {β}_{k} ) = {\sum }_{i = 1}^{p} {β}_{k , i} {h}_{k , i} ( x ) . \qquad ( 13 )$$

where β_{k,i} denotes the i^{th} calculation coefficient of the calculation parameters of the second Bayesian probability model correction term ηₖ, h_{k,i} is the ‘interpretation’ function of the shock wave load-related parameter correction term, and x is the variable of the ‘interpretation’ function.

Bayesian probability model parameter update: based on the observation data set yₖ, the posterior distribution of Bayesian probability model parameters is updated by the Bayesian theorem:

$$π ( {Θ}_{k} \vert {y}_{k} ) = \frac{L ( {y}_{k} \vert {Θ}_{k} ) π ( {Θ}_{k} )}{\int L ( {y}_{k} \vert {Θ}_{k} ) π ( {Θ}_{k} ) d {Θ}_{k}} = c \cdot L ( {y}_{k} \vert {Θ}_{k} ) π ( {Θ}_{k} ) . \qquad ( 14 )$$

In the formula, π(Θₖ) is the prior distribution of load representation parameters, which reflects the prior understanding of the overall parameter distribution; yₖ is the actual evidence sample vector, and yₖ=[y₁, y₂, . . . , yₙ]; Θₓ is the unknown parameter of the probability model; π(Θₖ|yₖ) is the posterior distribution of Bayesian probability model parameters, which reflects the update of prior after obtaining evidence sample information; L(yₖ|Θₖ) is the likelihood function, and which quantifies the consistency between the model and the data, L(yₖ|Θₖ)=L(y₁, y₂, . . . , yₙ, Θₖ); c is the definite integral constant, and c denotes the regularization factor. When the evidence sample information comes from n independent experimental sets, Formula (14) can be further expressed as:

$$π ( {Θ}_{k} \vert {y}_{k}^{1} , {y}_{k}^{2} , , {y}_{k}^{n} ) = c \cdot {\prod }_{i = 1}^{n} L ( {y}_{k}^{i} \vert {Θ}_{k} ) π ( {Θ}_{k} ) . \qquad ( 15 )$$

where i is the i^{th} data sample point of the n^{th} independent experimental data set, n is the number of independent experimental data sets, and π is the posterior distribution function.

Based on formula (12), the model calculation error is defined as:

$${r}_{k} ( x , {Θ}_{k} ) = {y}_{k} ( x , {Θ}_{k} ) - {y}_{k , d} ( x , {Θ}_{k} ) - {η}_{k} ( x , {β}_{k} ) . \qquad ( 16 )$$

where rₖ is the model calculation error, and y_{k,d} is the empirical model of underwater explosion shock wave load.

It is assumed that the calculation error of the model obeys the Gaussian normal distribution, the likelihood function is:

$$L ( {y}_{k} \vert {Θ}_{k} ) = {\prod }_{i = 1}^{n} \frac{1}{{σ}_{k}} {f}_{E} [ \frac{{r}_{k , i} ( x , {Θ}_{k} )}{{σ}_{k}} ] = \frac{1}{\sqrt{{( 2 π )}^{n} \vert {\sum }_{k} \vert}} exp \{ - \frac{1}{2} [ {{r}_{k} ( x , {Θ}_{k} )}^{T} {\sum }_{k}^{- 1} [ {r}_{k} ( x , {Θ}_{k} ) ] ] \} . \qquad ( 17 )$$

In the formula, Σₖ is the covariance matrix of the model calculation error. It is assumed that the Bayesian probability model parameters are independent of each other, the prior distribution of the Bayesian probability model parameters can adopt the uninformative prior distribution, that is, π(θₖ)∝1,π(βₖ)∝1, ∝(σₖ)∝1/σₖ. The prior distribution can be expressed as:

$$π ( {Θ}_{k} ) ∝ π ( {θ}_{k} ) π ( {β}_{k} ) π ( {σ}_{k} ) = \frac{1}{{σ}_{k}^{n}} . \qquad ( 18 )$$

Since the high-dimensional integral of the definite integral constant c is difficult to solve analytically, the present disclosure calculates the posterior distribution of the parameters of the Bayesian probability model by a Monte Carlo Markov Chain (MCMC) conditional sampling algorithm, such as a Gibbs sampling algorithm, a Metropolis-Hastings (MH) sampling algorithm, a delayed rejection adaptive MH sampling method, and the like. After the parameters of the Bayesian probability model are updated, the feature quantity of the posterior distribution of the parameters is typically selected as its estimated value, that is:

$${\hat{y}}_{k} ( x ) = {y}_{k} ( x , {\hat{Θ}}_{k} ) . \qquad ( 19 )$$

Or further, the posterior distribution sample Θ_{k,i}˜π(Θₖ|yₖ) is selected to calculate the shock wave load, and its mean value and variance can be expressed as follows:

$${\hat{y}}_{k} ( x ) = \frac{1}{n} {\sum }_{i = 1}^{n} {y}_{k} ( x , {Θ}_{k , i} ) . \qquad ( 20 )$$

$$Var [ {\hat{y}}_{k} ( x ) ] = \frac{1}{n - 1} E \{ y ( x , {Θ}_{k , i} ) - E [ {\hat{y}}_{k} ( x ) ] \} . \qquad ( 21 )$$

### Bayesian Probability Model Verification and Analysis

### (1) Bayesian Probability Model Parameter Selection

In view of the significant uncertainty of the parameters of the prior Bayesian probability model, if deterministic parameters are used for calculation and analysis, the deviation of the calculation results will be increased. Therefore, the Bayesian probability model parameter selection strategies are divided into two types:
Model I: (1) the first Bayesian probability model with prior model load representation parameters k^{s}=(kₚ, k_{θ}, k_{I}, kₑ), α^{s}=(αₚ, α_{θ}, α_{I}, αₑ) and the model error σ as the parameters of the Bayesian probability model.
Model II: The second Bayesian probability model with the model correction term parameter βₖ and the model error σ as the parameters of the Bayesian probability model, and the calculation result of the prior model is modified by the model correction term ηₖ(x,βₖ).

For the determination of the model modification term ηₖ(x,βₖ), it can be expressed by a linear combination of a series of basic elementary functions hᵢ(x) based on engineering experience and mechanism analysis. Studies have shown that the factors affecting the underwater explosion effect include: medium properties (atmospheric pressure, water density, sound velocity in water), explosive properties (charge shape, explosive mass, density, explosion velocity, explosion heat), explosion position (explosion distance, explosion depth), etc. Based on the above understanding, combined with dimensional analysis, the ‘interpretation’ function h(x) of the correction term of shock wave load-related parameters can be selected as:

$$h ( x ) = [ R / {r}_{0} , {ρ}_{w} / {ρ}_{e} , {c}_{w} / {c}_{e} , {Q}_{e} / {Q}_{TNT} ] . \qquad ( 19 )$$

In the formula, ρₑ, cₑ, Qₑ and r₀ are explosive density, explosion velocity, explosion heat and equivalent radius; Q_{TNT} is TNT explosion heat; p₀ is atmospheric pressure. For specific explosives and fluid media, ρₑ, cₑ, Qₑ and Q_{TNT} have been determined, so the ‘interpretation’ function introduces a constant term, and h(x) is further simplified as follows:

$$h ( x ) = [ 1 , R / {r}_{0} ] . \qquad ( 20 )$$

In consideration of the influence of higher-order terms, the model correction terms can be expressed as:

$${η}_{k} ( x , β ) = {β}_{k , 1} {h}_{k , 1} ( x ) + {β}_{k , 2} {h}_{k , 2} ( x ) + {β}_{k , 3} {h}_{k , 2}^{2} ( x ) . \qquad ( 21 )$$

### (2) Bayesian Probability Model Parameter Update Results:

In Tables 9 and 10, the parameter estimates and performance evaluations of probability models are compared under different sample sizes. The results of Model I in Table 9 show that Bayesian update has the advantage of sample efficiency. With the gradual increase of sample size from 8% to 100%, the posterior variance of Bayesian probability model parameters of θ, pₘ, I and eₛ shrinks systematically, which is consistent with the theoretical expectation of Bayesian update. RMSE of θ and pₘ models can reach a better level when the sample size is 16% and 60%, respectively, which has higher engineering application value, that is, it can take into account the test cost and efficiency while ensuring a certain level of model accuracy. The variance convergence of the Bayesian probability model parameters of I and eₛ is the fastest, but the change of RMSE is small, which reflects that the parameters of I and eₛ energy model are less affected by the sample size. And the data in Tables 9 and 10 are compared, the calculation results of Model II show that the posterior variance of Bayesian probability model parameters of θ, pₘ, I and eₛ also shrinks systematically, but the convergence is slow, and RMSE is insensitive to the change of sample size. Therefore, it reflects that the parameter dispersion of Model I is lower, which is more suitable for the working conditions when the explosive properties are known and the environment is simple, and Model II is more applicable to complex environments by quantifying the influence of the ‘interpretation’ function through the β system.

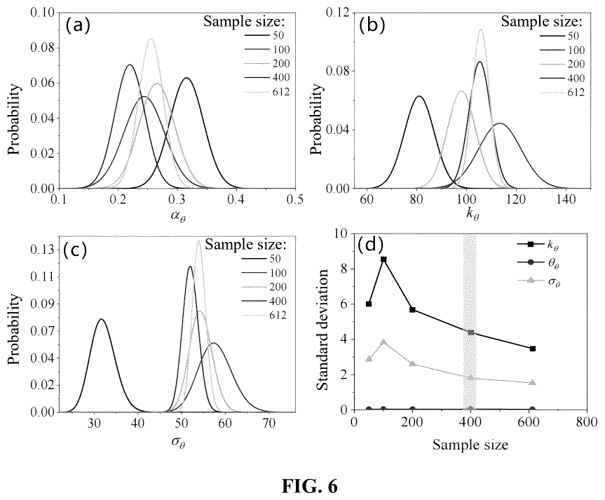

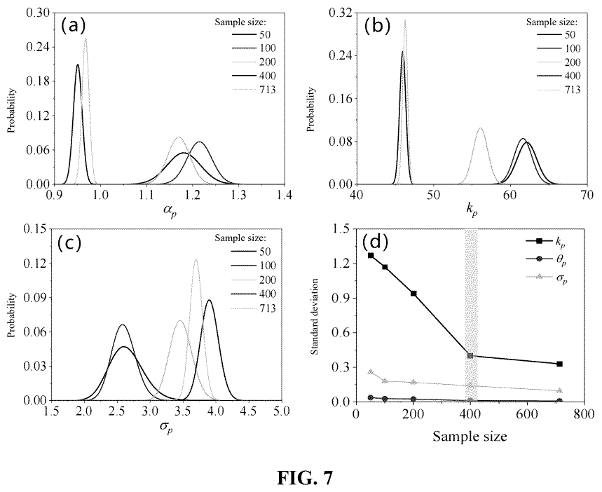

FIG. 6 and FIG. 7 show the evolution characteristics of the posterior distribution of the parameters of the probabilistic Bayesian probability model, respectively. The evolution of the posterior distribution indicates that the posterior exhibits broad tails and multiple peaks when the sample size is small (<20%), while it converges to a compact single peak when the full sample size is reached (100%). This means that the fit between the parameter posterior distribution and the actual situation continuously improves as the measured sample size increases. In combination with the data in Tables 9 and 10, the sampling can be stopped when the sample size reaches 40-60% during the Bayesian probability modeling process, thus achieving the optimal cost point.

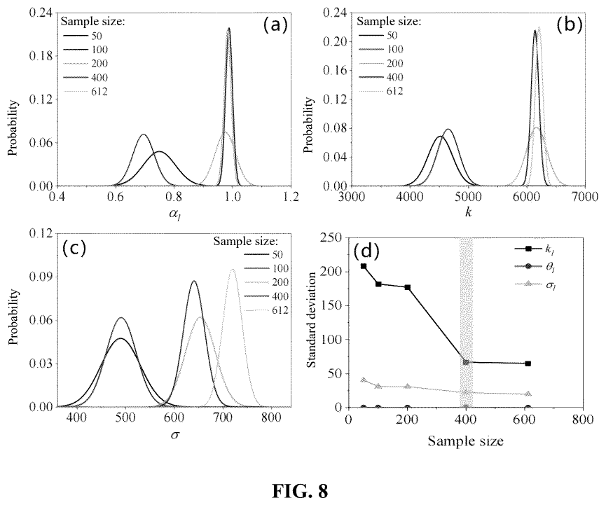

In Table 11 and FIG. 8, by comprehensively comparing the calculation accuracy of the prior model and the probability model, it can be seen that both probability model types based on the Bayesian method have high reliability. With the increase in the number of samples, the parameters of Model I show a smaller discrete type than the uncertain parameters of Model II, that is, the parameter uncertainty of Model I is lower. However, by introducing the interpretable term h(x), Model 2 actually comprehensively accounts for the effects of explosive density, shape, explosion velocity, explosion heat and equivalent, while these influencing factors are not considered in the prior model and Model I, which significantly improves the physical interpretability of the model.

TABLE 9
Mean value, standard deviation and model evaluation of each load representation parameter of Model I

| | | k | | α | | σ | | Evaluation | | |
|---|---|---|---|---|---|---|---|---|---|---|
| Load | Sample size | Mean | Standard | Mean | Standard | Mean | Standard | indicator | | |
| representation | (Proportion) | value | deviation | value | deviation | value | deviation | RMSE | R² | Cov |
| θ | 50(8.43%) | 81.05 | 6.02 | −0.32 | 0.029 | 32.03 | 2.87 | 43.78 | 0.76 | 0.39 |
| | 100(16.86%) | 113.4 | 8.55 | −0.24 | 0.035 | 57.67 | 3.84 | 39.84 | 0.80 | 0.52 |
| | 200(33.73%) | 98 | 5.69 | −0.27 | 0.03 | 54.35 | 2.60 | 39.68 | 0.81 | 0.43 |
| | 400(67.45%) | 105.4 | 4.38 | −0.22 | 0.026 | 52.02 | 1.80 | 39.84 | 0.80 | 0.44 |
| | 593(100%) | 105.8 | 3.48 | −0.26 | 0.022 | 53.93 | 1.53 | 39.11 | 0.81 | 0.47 |
| pₘ | 50(7.39%) | 62.14 | 1.27 | 1.18 | 0.036 | 2.64 | 0.26 | 8.50 | 0.70 | 0.27 |
| | 100(14.77%) | 61.63 | 1.17 | 1.22 | 0.027 | 2.60 | 0.18 | 8.73 | 0.69 | 0.24 |
| | 200(29.54%) | 56.09 | 0.94 | 1.17 | 0.024 | 3.47 | 0.17 | 6.52 | 0.83 | 0.22 |
| | 400(59.08%) | 45.98 | 0.40 | 0.95 | 0.0095 | 3.91 | 0.14 | 3.72 | 0.94 | 0.28 |
| | 677(100%) | 46.28 | 0.33 | 0.97 | 0.0078 | 3.70 | 0.097 | 3.70 | 0.94 | 0.26 |
| I | 50(8.43%) | 4518 | 208.2 | 0.75 | 0.055 | 489.80 | 40.42 | 781.30 | 0.82 | 0.53 |
| | 100(16.86%) | 4653 | 181.8 | 0.69 | 0.038 | 490.80 | 30.99 | 740.21 | 0.84 | 0.57 |
| | 200(33.73%) | 6166 | 177.2 | 0.97 | 0.035 | 653.70 | 30.85 | 518.62 | 0.92 | 0.53 |
| | 400(67.45%) | 6141 | 66.64 | 0.99 | 0.012 | 640.60 | 21.97 | 525.94 | 0.92 | 0.53 |
| | 593(100%) | 6209 | 65.01 | 0.98 | 0.012 | 719.4 | 20.04 | 516.72 | 0.92 | 0.53 |
| eₛ | 50(9.04%) | 96.85 | 5.32 | 1.96 | 0.18 | 9.22 | 0.87 | 6.33 | 0.96 | 0.81 |
| | 100(18.08%) | 97.15 | 3.64 | 1.99 | 0.096 | 6.83 | 0.47 | 6.80 | 0.96 | 0.77 |
| | 200(36.17%) | 94.40 | 1.86 | 2.05 | 0.051 | 5.85 | 0.29 | 7.42 | 0.95 | 0.68 |
| | 400(72.33%) | 87.52 | 1.12 | 1.96 | 0.013 | 7.71 | 0.27 | 6.07 | 0.96 | 0.70 |
| | 553(100%) | 88.97 | 0.92 | 1.95 | 0.011 | 8.06 | 0.24 | 5.94 | 0.97 | 0.73 |

TABLE 10
Mean value, standard deviation and model evaluation of each load representation parameter of Model II

| | | β₁ | | β₂ | | β₃ | | σ | | Evaluation | | |
|---|---|---|---|---|---|---|---|---|---|---|---|---|
| Load | Sample size | Mean | Standard | Mean | Standard | Mean | Standard | Mean | Standard | indicator | | |
| representation | (Proportion) | value | deviation | value | deviation | value | deviation | value | deviation | RMSE | R² | Cov |
| θ | 50(8.17%) | −23.65 | 9.50 | 0.16 | 0.13 | −2.22 × | 2.16 × | 32.05 | 2.91 | 42.89 | 0.77 | 0.40 |
| | | | | | | 10⁻⁴ | 10⁻⁴ | | | | | |
| | 100(16.34%) | −9.01 | 13.52 | 0.44 | 0.17 | −8.23 × | 2.89 × | 55.96 | 3.70 | 38.95 | 0.81 | 0.51 |
| | | | | | | 10⁻⁴ | 10⁻⁴ | | | | | |
| | 200(32.68%) | −2.38 | 8.62 | 0.061 | 0.12 | −1.22 × | 2.15 × | 54.47 | 2.63 | 39.46 | 0.81 | 0.44 |
| | | | | | | 10⁻⁴ | 10⁻⁴ | | | | | |
| | 400(65.36%) | 10.74 | 6.08 | −0.14 | 0.091 | 2.21 × | 1.72 × | 52.04 | 1.82 | 40.22 | 0.80 | 0.45 |
| | | | | | | 10⁻⁴ | 10⁻⁴ | | | | | |
| | 593(100%) | 1.34 | 5.10 | 0.14 | 0.08 | −2.91 × | 1.58 × | 53.87 | 1.53 | 38.80 | 0.81 | 0.47 |
| | | | | | | 10⁻⁴ | 10⁻⁴ | | | | | |
| pₘ | 50(7.01%) | 6.46 | 1.02 | −0.051 | 0.013 | 7.39 × | 2.33 × | 3.46 | 0.34 | 5.95 | 0.86 | 0.36 |
| | | | | | | 10⁻⁵ | 10⁻⁵ | | | | | |
| | 100(14.02%) | 4.79 | 0.75 | −0.044 | 0.0094 | 6.65 × | 1.62 × | 3.18 | 0.22 | 5.34 | 0.88 | 0.30 |
| | | | | | | 10⁻⁵ | 10⁻⁵ | | | | | |
| | 200(28.04%) | 2.19 | 0.58 | −0.021 | 0.008 | 3.27 × | 1.46 × | 3.67 | 0.18 | 4.86 | 0.90 | 0.23 |
| | | | | | | 10⁻⁵ | 10⁻⁵ | | | | | |
| | 400(56.08%) | −1.54 | 0.65 | 0.025 | 0.0094 | −4.37 × | 1.81 × | 5.57 | 0.20 | 4.73 | 0.91 | 0.29 |
| | | | | | | 10⁻⁵ | 10⁻⁵ | | | | | |
| | 677(100%) | −0.55 | 0.42 | 0.012 | 0.0065 | −2.18 × | 1.33 × | 4.71 | 0.12 | 4.71 | 0.91 | 0.24 |
| | | | | | | 10⁻⁵ | 10⁻⁵ | | | | | |
| I | 50(8.17%) | −410.5 | 147.9 | 4.35 | 1.95 | −6.50 × | 3.37 × | 515.1 | 43.11 | 694.58 | 0.86 | 0.52 |
| | | | | | | 10⁻³ | 10⁻³ | | | | | |
| | 100(16.34%) | −115.4 | 122.2 | 3.25 | 1.51 | −5.52 × | 2.62 × | 522.9 | 33.46 | 608.12 | 0.89 | 0.55 |
| | | | | | | 10⁻³ | 10⁻³ | | | | | |
| | 200(32.68%) | 321.3 | 103.9 | −3.20 | 1.42 | 5.25 × | 2.59 × | 670.5 | 31.66 | 557.96 | 0.91 | 0.54 |
| | | | | | | 10⁻³ | 10⁻³ | | | | | |
| | 400(65.36%) | 428.6 | 82.83 | −5.27 | 1.14 | 9.03 × | 2.36 × | 713.9 | 14.52 | 554.49 | 0.91 | 0.55 |
| | | | | | | 10⁻³ | 10⁻³ | | | | | |
| | 593(100%) | 377.6 | 71.95 | −3.87 | 1.18 | 6.53 × | 2.33 × | 775.4 | 21.70 | 552.94 | 0.91 | 0.55 |
| | | | | | | 10⁻³ | 10⁻³ | | | | | |
| eₛ | 50(8.74%) | 7.85 | 2.90 | −0.066 | 0.038 | 9.81 × | 9.82 × | 9.73 | 0.92 | 6.67 | 0.96 | 0.63 |
| | | | | | | 10⁻⁴ | 10⁻⁴ | | | | | |
| | 100(17.45%) | 5.94 | 1.72 | −0.052 | 0.021 | 7.84 × | 3.67 × | 7.24 | 0.50 | 6.02 | 0.97 | 1.45 |
| | | | | | | 10⁻⁴ | 10⁻⁴ | | | | | |
| | 200(34.90%) | 3.75 | 1.01 | −0.039 | 0.014 | 6.23 × | 2.55 × | 6.30 | 0.31 | 6.14 | 0.96 | 1.27 |
| | | | | | | 10⁻⁴ | 10⁻⁴ | | | | | |
| | 400(69.80%) | 4.61 | 0.92 | −0.050 | 0.014 | 8.04 × | 2.63 × | 7.98 | 0.28 | 6.08 | 0.96 | 1.57 |
| | | | | | | 10⁻⁴ | 10⁻⁴ | | | | | |
| | 553(100%) | 4.66 | 0.81 | −0.055 | 0.013 | 9.07 × | 2.56 × | 8.34 | 0.25 | 6.09 | 0.96 | 1.82 |
| | | | | | | 10⁻⁴ | 10⁻⁴ | | | | | |

TABLE 11
Evaluation of model calculation results

| | Evaluation | | | | | | | | |
|---|---|---|---|---|---|---|---|---|---|
| | indicator of | | | Model I (100% sample | | | Model II (100% sample | | |
| Model | priori models | | | proportion) | | | proportion) | | |
| parameter | RMSE | R² | Cov | RMSE | R² | Cov | RMSE | R² | Cov |
| θ | 41.13 | 0.75 | 0.42 | 39.11~43.78 | 0.76~0.81 | 0.39~0.47 | 38.80~42.89 | 0.77~0.81 | 0.40~0.51 |
| pₘ | 5.37 | 0.84 | 0.22 | 3.70~8.50 | 0.70~0.94 | 0.22~0.28 | 4.71~5.95 | 0.86~0.91 | 0.23~0.36 |
| I | 504.92 | 0.92 | 0.57 | 516.72~781.30 | 0.82~0.92 | 0.53~0.57 | 552.94~694.58 | 0.86~0.91 | 0.52~0.55 |
| eₛ | 6.86 | 0.95 | 1.03 | 5.94~7.42 | 0.95~0.97 | 0.68~0.81 | 6.02~6.67 | 0.96~0.97 | 0.63~1.82 |

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A probabilistic representation method for underwater explosion shock wave load based on Bayesian reasoning, comprising the following steps:
S1, acquiring past experimental data, and obtaining sample data by analyzing and processing the past experimental data;
S2, taking a Cole empirical model as a prior model of Bayesian inference, and obtaining a target probability distribution of load representation parameters and calculation errors by performing an uncertainty analysis on load representation parameters and calculation errors of the prior model in combination with the sample data;
S3, taking the target probability distribution as prior knowledge, updating and calculating the load representation parameters and calculation errors by using the Bayesian inference method, and obtaining a Bayesian probability model of underwater explosion shock wave load; and
S4, based on the Bayesian probability model of underwater explosion shock wave load, predicting and calculating the underwater explosion shock wave load.

2. The probabilistic representation method for underwater explosion shock wave load based on Bayesian reasoning according to claim 1, wherein in S2, the specific steps of taking the Cole empirical model as the prior model of Bayesian inference comprise:
obtaining a pressure time history expression of underwater explosion shock waves based on a Cole's empirical formula, and then deriving the load representation parameters of underwater explosion shock waves;
wherein the load representation parameters comprise a free field shock wave pressure peak pₘ, a time constant θ, an impulse I, and a shock wave specific energy density eₛ; and,
establishing a dimensionless empirical model for the load representation parameters.

3. The probabilistic representation method for underwater explosion shock wave load based on Bayesian reasoning according to claim 2, wherein the pressure time history expression of underwater explosion shock is:
$$p ( t ) = {p}_{m} {e}^{- t / θ} ;$$
where p(t) is a pressure time history of an underwater explosion shock wave; pₘ is the free field shock wave pressure peak; θ is the time constant, defined as a time that the peak value of the shock wave attenuates from pₘ to pₘ/e, t is a time, m is an explosive equivalent, and e is a natural constant;
wherein, based on the pressure time history expression of underwater explosion shock, a water density ρ_{w} and an underwater acoustic propagation velocity c_{w} are introduced, and the impulse I and the shock wave specific energy density eₛ are derived.

4. The probabilistic representation method for underwater explosion shock wave load based on Bayesian reasoning according to claim 3, wherein the expression of the dimensionless empirical model is:
$$y = {{k}_{d} ( \frac{1}{Z} )}^{{α}_{d}} ;$$
wherein y is a response variable defined by the formula y=(pₘ, θ/m^{1/3}, I/m^{1/3}, eₛ/m^{1/3}), where m^{1/3} denotes a ⅓ power of the explosive equivalent;
wherein the load representation parameters are k_{d}=(kₚ, k_{θ}, k_{I}, kₑ), and α_{d}=(αₚ, α_{θ}, α_{I}, αₑ), where k_{d} and α_{d} denote a first calculation parameter and a second calculation parameter of the dimensionless empirical model expression, calculated via calculation parameters kₚ and αₚ of a pressure peak prior model, calculation parameters k_{θ} and α_{θ} of a time constant prior model, calculation parameters k_{I} and α_{I} of an impulse prior model, and calculation parameters kₑ and αₑ of a shock wave specific energy density prior model;
where a scaled explosion distance Z can be expressed as:
$$Z = \frac{R}{{( m \cdot NEQ )}^{1 / 3}} ;$$
wherein R is an explosion distance; m is a mass of explosive; and NEQ is a TNT equivalent.

5. The probabilistic representation method for underwater explosion shock wave load based on Bayesian reasoning according to claim 1, wherein in S2, the specific step of obtaining the target probability distribution of load representation parameters and calculation errors by performing the uncertainty analysis on the load representation parameters and calculation errors of the prior model in combination with the sample data comprises:
presetting optional probability distribution types, wherein the optional probability distribution types comprise but are not limited to Normal distribution, Lognormal distribution, Weibull distribution and Gamma distribution;
fitting the load representation parameters by using the sample data, and obtaining power-law relationship characteristics between the load representation parameters and the scaled explosion distance Z;
obtaining goodness-of-fit test results by performing a goodness-of-fit test on the load representation parameters and optional probability distribution types using Anderson-Darling statistical values;
determining the target probability distribution of the load representation parameters according to the power-law relationship characteristics and the goodness-of-fit test results;
evaluating the Cole dimensionless empirical model by using a root mean square error RMSE, a coefficient of determination R² and a variation coefficient Cov, and then quantifying a deviation of the dimensionless empirical model to obtain a model error ME;
performing an Anderson-Darling goodness-of-fit test on interval characteristics of ME by dividing the scaled explosion distance Z into sections, and then determining the target probability distribution of the calculation error among the optional probability distribution types.

6. The probabilistic representation method for underwater explosion shock wave load based on Bayesian reasoning according to claim 5, wherein the expression of the model error ME is:
$$ME = \frac{{y}_{test}}{{y}_{cal}} ;$$
wherein yₜₑₛₜ is a test value; and y_{cal} is a calculated value of the model.

7. The probabilistic representation method for underwater explosion shock wave load based on Bayesian reasoning according to claim 1, wherein the expression of the Bayesian probability model of underwater explosion shock wave load comprises:
(1) a first Bayesian probability model with prior model load representation parameters k^{s}=(kₚ, k_{θ}, k_{I}, kₑ), α^{s}=(αₚ, α_{θ}, α_{I}, αₑ), and the model error σ as the parameters of the Bayesian probability model;
$${y}_{k} ( x , {Θ}_{k} ) = {y}_{k , d} ( x , {θ}_{k} ) + {σ}_{k} {ε}_{k} ;$$
(2) a second Bayesian probability model with a model correction term parameter βₖ and the model error σ as the parameters of the Bayesian probability model, which is used to correct the calculation results of the prior model through a model correction term ηₖ(x,βₖ);
$${y}_{k} ( x , {Θ}_{k} ) = {y}_{k , d} ( x , {θ}_{k} ) + {η}_{k} ( x , {β}_{k} ) + {σ}_{k} {ε}_{k} ;$$
wherein yₖ(x,Θₖ) is a probability model of the representation parameters of underwater explosion load, and the subscript k denotes different representation parameters, and wherein y_{k,d}(x,θₖ) and ηₖ(x,βₖ) are empirical models and their correction terms, respectively; x is an observable input random variable; Θₖ=(θₖ, βₖ, σₖ) is an unknown parameter of the probability model; σₖε_{K} denotes a calculation error of the modified probability model; where σₖ is a standard deviation of the model, εₖ is a random variable that obeys the standard normal distribution, and θₖ denotes calculation parameters k_{d} and α_{d} of the empirical model y_{k,d}; and βₖ is a calculation parameter of the second Bayesian probability model correction term ηₖ;
defining that the model variance σₖ² is mutually independent and linearly unrelated to the variable x, that is, for a given load representation parameter Θₖ, a variance of the probability model is Var[P(x,Θₖ)]=σₖ²;
wherein the expression of the model correction term ηₖ(x,βₖ) is:
$${η}_{k} ( x , β ) = {β}_{k , 1} {h}_{k , 1} ( x ) + {β}_{k , 2} {h}_{k , 2} ( x ) + {β}_{k , 3} {h}_{k , 2}^{2} ( x ) ;$$
where β_{k,i} denotes an i^{th} calculation coefficient of the calculation parameters of the second Bayesian probability model correction term ηₖ, h_{k,i} is an ‘interpretation’ function of the shock wave load-related parameter correction term, and x is a variable of the ‘interpretation’ function.

8. The probabilistic representation method for underwater explosion shock wave load based on Bayesian reasoning according to claim 7, wherein based on an observation data set yₖ, a posterior distribution of Bayesian probability model parameters is updated by the Bayesian theorem, wherein the posterior distribution expression of Bayesian probability model parameters is as follows:
$$π ( {Θ}_{k} \vert {y}_{k} ) = \frac{L ( {y}_{k} \vert {Θ}_{k} ) π ( {Θ}_{k} )}{\int L ( {y}_{k} \vert {Θ}_{k} ) π ( {Θ}_{k} ) d {Θ}_{k}} = c \cdot L ( {y}_{k} \vert {Θ}_{k} ) π ( {Θ}_{k} ) ;$$
wherein π(Θₖ) is a prior distribution of Bayesian probability model parameters; yₖ is an actual evidence sample vector, and yₖ=[y₁, y₂, . . . , yₙ]; Θₖ is an unknown parameter of the probability model; π(Θₓ|yₖ) is a posterior distribution of Bayesian probability model parameters; L(yₖ|Θₖ) is a likelihood function, and the consistency between the model and the data is quantified, L(yₖ|Θₖ)=L(y₁, y₂, . . . , yₙ, Θₖ); and c is a definite integral constant, and c denotes a regularization factor.

9. The probabilistic representation method for underwater explosion shock wave load based on Bayesian reasoning according to claim 8, wherein when the evidence sample information comes from n independent experimental sets, and the posterior distribution expression of Bayesian probability model parameters can be further expressed as:
$$π ( {Θ}_{k} \vert {y}_{k}^{1} , {y}_{k}^{2} , … , {y}_{k}^{n} ) = c \cdot {\prod }_{i = 1}^{n} L ( {y}_{k}^{i} \vert {Θ}_{k} ) π ( {Θ}_{k} ) ;$$
where i is an i^{th} data sample point of an n^{th} independent experimental data set, n is a number of independent experimental data sets, and π is a posterior distribution function;
wherein, according to the Bayesian probability model of underwater explosion shock wave load, the model calculation error is defined, and the expression of the model calculation error is as follows:
$${r}_{k} ( x , {Θ}_{k} ) = {y}_{k} ( x , {Θ}_{k} ) - {y}_{k , d} ( x , {θ}_{k} ) - {η}_{k} ( x , {β}_{k} ) ;$$
where rₖ is a model calculation error, and y_{k,d} is an empirical model of underwater explosion shock wave load.
